(19) United States
(12) Patent Application Publication
(10) Pub. No.: US 2025/0127145 A1
(43) Pub. Date: Apr. 24, 2025

(54) PET HARNESS APPARATUS

(71) Applicant: Picket Protector LLC, Myrtle Beach, SC (US)

(72) Inventors: Douglas A. Hopper, Longs, SC (US); Karen L. Hopper, Longs, SC (US)

(73) Assignee: Picket Protector LLC, Myrtle Beach, SC (US)

(21) Appl. No.: 18/492,338

(22) Filed: Oct. 23, 2023

(51) Int. Cl. A01K 15/00; A01K 27/00

(52) U.S. Cl. CPC A01K 15/006; A01K 27/002

(57) ABSTRACT

A pet harness apparatus may include a vest configured to be removably adhered to a pet body. The vest may include a vest interior surface and a vest exterior surface. The apparatus may further include a rigid elongated member, a first attachment mechanism and a second attachment mechanism. The first attachment mechanism may be disposed on the vest exterior surface and the second attachment mechanism may be disposed on the rigid elongated member. The first attachment mechanism may be configured to be removably attached to the second attachment mechanism to enable removable attachment between the vest and the rigid elongated member. Further, a rigid elongated member longitudinal axis may be perpendicular to a pet body length when the first attachment mechanism may be attached to the second attachment mechanism.

### TECHNICAL FIELD

The present disclosure relates to a pet harness apparatus, and more specifically to a pet harness apparatus that prevents pet movement through narrow spaces or gaps.

### BACKGROUND

Many people keep pets such as dogs, cats, etc. in their homes. Pets require healthy and safe surroundings for their physical and mental development. Pet owners employ many safety measures to keep their pets safe. For example, many pet owners build/install fences around their homes, gardens, etc. to ensure that their pets do not escape the safe home surroundings.

Even after installing the fences, the pet owners may still desire to implement additional safety measures to safeguard their pets. This is especially true as there are known instances of pets escaping through the fences (e.g., through the gaps between adjacent fences), and hence endangering their safety. Further, there are known instances of pets getting stuck between the gaps between adjacent fences while attempting to escape, which may result in injuries to the pets.

Thus, there is a need for a system that may effectively prevent pets from escaping through the fences.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts an isometric view of an example pet harness apparatus in accordance with the present disclosure.

FIG. 3 depicts a disassembled view of a first example rigid elongated member and a vest associated with a pet harness apparatus in accordance with the present disclosure.

FIG. 4 depicts a second example rigid elongated member in accordance with the present disclosure.

FIG. 5 depicts a third example rigid elongated member in accordance with the present disclosure.

### DETAILED DESCRIPTION

### Overview

The present disclosure is directed to a pet harness apparatus (“apparatus”) that may prevent a pet from escaping through gaps present between adjacent fences. The apparatus may include a vest, an elongated bar/tube, one or more vest attachment mechanisms and one or more bar attachment mechanisms. The vest may be worn by the pet, and the vest attachment mechanisms may be disposed on a vest exterior surface. The bar attachment mechanisms may be deposed on the elongated bar and may be configured to removably attach with the vest attachment mechanisms to enable removable attachment between the vest and the elongated bar. In some aspects, a bar longitudinal axis may be perpendicular to a pet length/longitudinal axis when the pet may be wearing the vest with the elongated bar attached to the vest. Since the bar longitudinal axis may be perpendicular to the pet length, the elongated bar may prevent/obstruct pet movement through the gaps present between adjacent fences when the pet attempts to cross the fences via the gaps. In this manner, the apparatus prevents pet escape through the fences. In some aspects, an elongated bar length may be greater than a width of gaps present between adjacent fences, which may ensure that the pet does not escape through the gaps.

In an exemplary aspect, the vest attachment mechanisms are D-rings (or eye bolts) and the bar attachment mechanisms may be carabiners, although the present disclosure is not limited to such attachment mechanisms. Further, in some aspects, the vest and bar attachment mechanisms enable vest attachment with the elongated bar in proximity to a vest back portion (or a pet back portion when the pet wears the vest).

The apparatus may include one or more additional components that may enhance ease of apparatus usage for the pet owner. For example, the apparatus/elongated bar may include a telescoping mechanism disposed on the elongated bar, which may enable the pet owner to adjust the elongated bar length based on the width of gaps between adjacent fences. Furthermore, the elongated bar may have a hollow interior portion that may be accessed by the pet owner via one or more openings disposed at an elongated bar proximal end and/or distal end. The pet owner may use the hollow interior portion to store one or more artifacts, e.g., pet litter/poop bags, pet snacks, an electronic pet locating device, and/or other small objects. The apparatus may further include one or more removable caps that may be disposed at the elongated bar proximal end and/or distal end, and the pet owner may access the openings associated with the elongated bar via the removable caps.

The present disclosure discloses a pet harness apparatus that may prevent a pet from escaping through gaps present between adjacent fences. The apparatus is lightweight and comfortable for the pet to wear. The apparatus may also be used to store small artifacts associated with the pet, thus enhancing apparatus usability for the pet owner. Further, since the elongated bar includes the telescoping mechanism, the apparatus may be used to prevent pet escape through fences of different sizes and arrangements.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

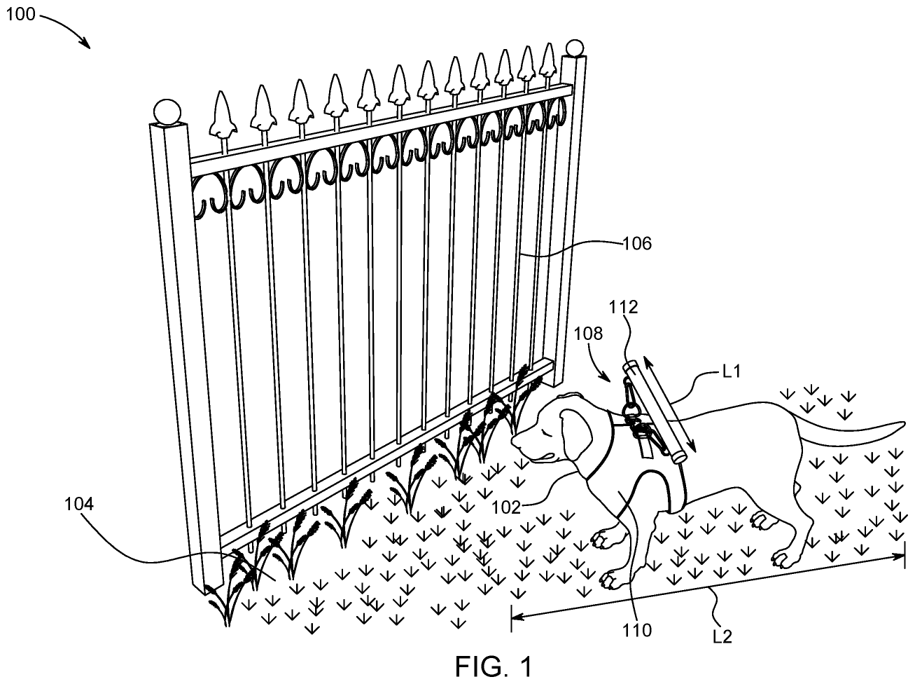

FIG. 1 depicts an example environment 100 in which techniques and structures for providing the systems and methods disclosed herein may be implemented. The environment 100 may include a pet 102 located in a garden 104 (or in any other outdoor environment). The pet 102 may be, for example, a dog, a cat, or any other pet animal. Although FIG. 1 depicts the pet 102 to be a dog, the present disclosure is not limited to the aspect of the pet 102 being a dog.

The garden 104 may be associated with or may surround a pet home (not shown). The garden 104 may include fences 106 that may be disposed/installed on garden boundaries to ensure that the pet 102 does not escape the garden 104 (and to prevent any foreign entity from entering the garden 104). In some aspects, the fences 106 may be installed by a pet owner (not shown) to prevent the pet 102 from encountering any adverse situation.

In some aspects, to prevent the pet 102 from attempting to escape through the gaps present between adjacent fences (and hence to prevent the pet 102 from hurting itself), the pet owner may removably secure/attach a pet harness apparatus 108 (or apparatus 108) to the pet 102. Specifically, the pet 102 may be wearing the apparatus 108 that may be configured to prevent the pet 102 from escaping through the gaps present between adjacent fences.

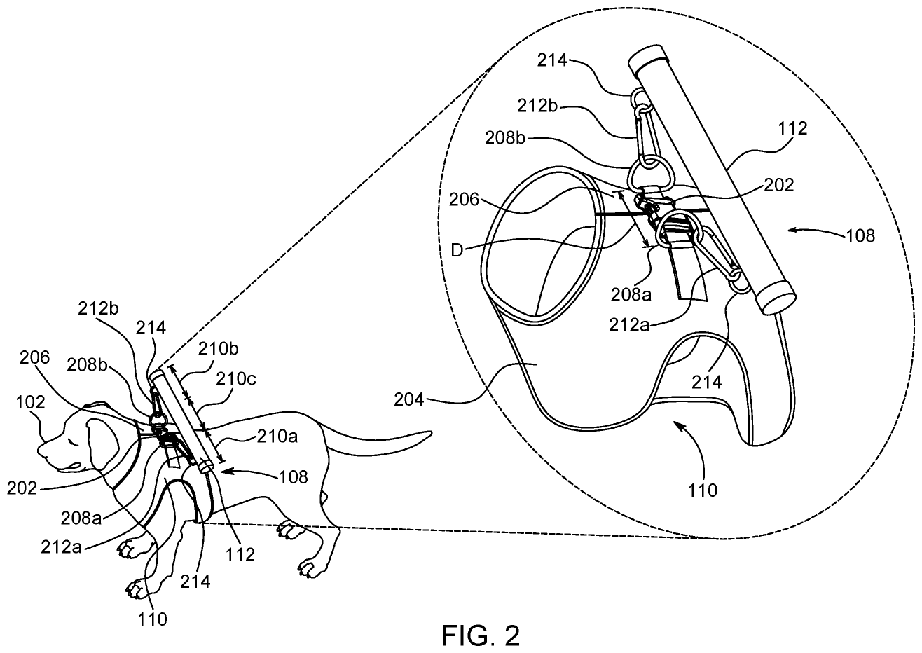

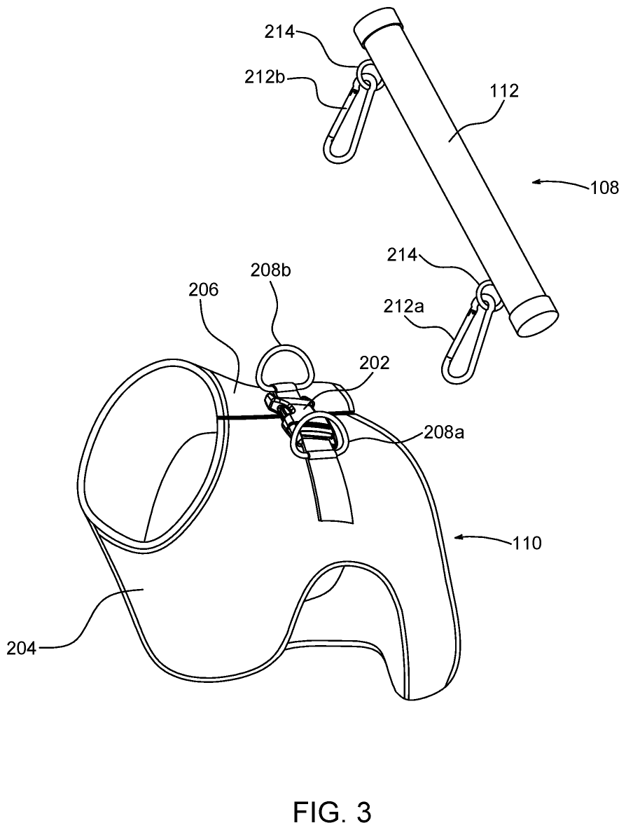

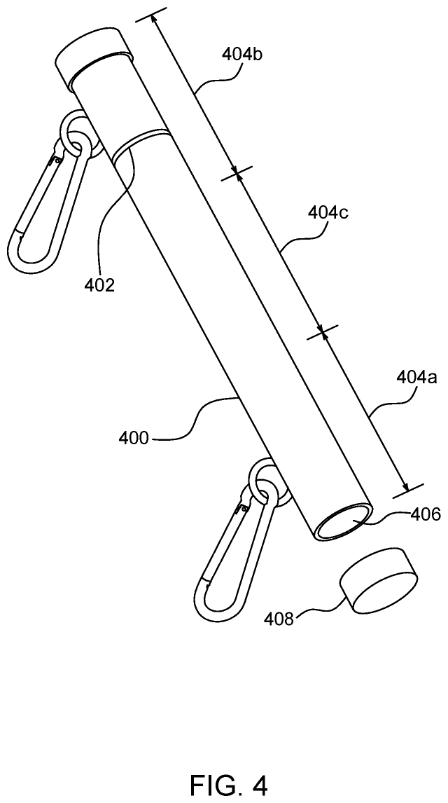

The apparatus 108 may include a vest 110 and a rigid elongated member 112. The vest 110 may be a pet harness system that may be configured to be worn by the pet 102. The rigid elongated member 112 may be an elongated rod, bar or tube made of plastic, aluminum, or any other metal or alloy. The rigid elongated member 112 may be shaped as a cylindrical, cuboidal, pentagonal, hexagonal or octagonal bar/rod/tube. In some aspects, the rigid elongated member 112 may be removably attached to the vest 110 via one or more attachment means/mechanisms, described below in conjunction with FIGS. 2 and 3. Further, in some aspects, the rigid elongated member 112 may have a hollow interior portion, as described below in conjunction with FIG. 4.

In an exemplary aspect, when the rigid elongated member 112 may be attached to the vest 110, a rigid elongated member longitudinal axis “L1” may be perpendicular to a pet longitudinal axis “L2” or a pet length, as shown in FIG. 1. Such an arrangement of the rigid elongated member 112 relative to the pet length/longitudinal axis “L2” ensures that when the pet 102 attempts to escape through the gaps present between adjacent fences, the rigid elongated member 112 may touch the adjacent fences via rigid elongated member distal and proximal portions (or left and right portions), thereby blocking the pet movement through the gaps present between adjacent fences. In this manner, the apparatus 108 may prevent the pet 102 from escaping through the fences 106.

Structural details of the apparatus 108 are described below in conjunction with FIGS. 2 and 3.

FIG. 2 depicts an isometric view of the pet harness apparatus 108 in accordance with the present disclosure. While describing FIG. 2, references will be made to FIG. 3, which depicts a disassembled or detached view of the rigid elongated member 112 and the vest 110 associated with the apparatus 108.

The vest 110 may be configured to be removably adhered to a pet body covering, e.g., a pet chest portion and a pet back portion, as shown in FIG. 2. The vest 110 may be made of flexible and deformable fabric, nylon, polyester, and/or any other material that may be comfortable for the pet 102 to wear. The vest 110 may include a vest interior surface and a vest exterior surface. The vest interior surface may touch the pet body/skin when the vest 110 may be adhered to the pet body. In some aspects, the vest 110 may be a pet harness or a pet cape that may include one or more fasteners 202 that may enable the pet owner to conveniently fasten and secure the vest 110 around the pet body. The fasteners 202 may be, for example, buckles (e.g., side release buckles), clasps, zippers, and/or the like. Although FIG. 2 depicts the fastener 202 to be disposed in proximity to a pet back portion (or a back neck portion) when the pet 102 wears the vest 110, the present disclosure is not limited to such an arrangement. The fasteners 202 may be disposed anywhere on the vest 110 (e.g., in proximity to the pest chest portion when the pet 102 wears the vest 110), such that the pet owner may conveniently fasten and secure the vest 110 around the pet body. A person ordinarily skilled in the art may appreciate that the vest 110 may include one or more additional components, e.g., a chest strap, a neck strap, a back strap, a girth strap, and/or the like, which may enable the pet owner to conveniently fasten and secure the vest 110 around the pet body. Such additional components are not shown in FIGS. 2 and 3 for the sake of simplicity.

In some aspects, the vest 110 may include a vest front portion 204 and a vest back portion 206. The vest front portion 204 may secure/cover the pet chest portion when the pet 102 wears the vest 110, and the vest back portion 206 may secure/cover the pet back portion when the pet 102 wears the vest 110. In the exemplary aspect depicted in FIGS. 2 and 3, the fastener 202 is shown as being disposed on the vest back portion 206.

The vest 110 may further include one or more vest attachment mechanisms that may be disposed on or attached to the vest exterior surface. For example, as shown in FIGS. 2 and 3, the vest 110 may include a first vest attachment mechanism 208a and a second vest attachment mechanism 208b. In some aspects, the first and second vest attachment mechanisms 208a, 208b may be disposed on or attached to a middle part (or portion) of the vest back portion 206. Specifically, the first vest attachment mechanism 208a may be disposed at a proximal or right end of the middle part (or portion) of the vest back portion 206, and the second vest attachment mechanism 208b may be disposed at a distal or left end of the middle part (or portion) of the vest back portion 206. In some aspects, the first and second vest attachment mechanisms 208a, 208b may be disposed on or attached to the middle part (or portion) of the vest back portion 206 such that a predefined distance “D” (i.e., a non-zero distance) may exist between the first and second vest attachment mechanisms 208a, 208b, as shown in FIG. 2. In the exemplary aspect depicted in FIGS. 2 and 3, the fastener 202 is shown to be positioned/disposed between the first and second vest attachment mechanisms 208a, 208b in the distance “D”, although the present disclosure is not limited to such an arrangement. The arrangement of the first and second vest attachment mechanisms 208a, 208b shown in FIGS. 2 and 3 is exemplary in nature and should not be construed as limiting.

The first and second vest attachment mechanisms 208a, 208b may be similar to/same as each other, and may be, for example, eye bolts, D-rings, carabiners, snap hooks, and/or the like. In the exemplary and preferred aspect depicted in FIGS. 2 and 3, the first and second vest attachment mechanisms 208a, 208b are D-rings. Further, the first and second vest attachment mechanisms 208a, 208b may be attached to the vest exterior surface by known attachment methods including, but not limited to, usage of straps, stitching, adhesives, and/or the like.

As described above in conjunction with FIG. 1, the rigid elongated member 112 may be shaped as a cylindrical, cuboidal, pentagonal, hexagonal or octagonal bar/rod/tube. The rigid elongated member 112 may be of any length (depending on the width of the gaps between adjacent fences 106) and cross-sectional diameter/width, and may be made of lightweight material such as plastic, aluminum, or any other metal/alloy. The rigid elongated member 112 may not be flexible or deformable, and hence may not bend when the pet 102 pushes against the fences 106 (wearing the apparatus 108), while attempting to escape through the gap between the adjacent fences. Stated another way, the rigid elongated member 112 may not bend when the rigid elongated member 112 touches the adjacent fences and the pet 102 pushes against the fences 106.

The rigid elongated member 112 may include a proximal portion 210a, a distal portion 210b, and a middle portion 210c disposed between the distal portion 210b and the proximal portion 210a. The rigid elongated member 112 may further include one or more bar attachment mechanisms that may be disposed on/attached to one or more of the proximal portion 210a, the distal portion 210b and the middle portion 210c. For example, as shown in FIGS. 2 and 3, a first bar attachment mechanism 212a may be disposed on/attached to the proximal portion 210a, and a second bar attachment mechanism 212b may be disposed on/attached to the distal portion 210b. In some aspects, the first and second bar attachment mechanisms 212a, 212b may be attached to the proximal portion 210a and the distal portion 210b respectively via one or more fasteners, e.g., hooks 214 (as shown in FIGS. 2 and 3), screws, bolts, nuts, or any other similar fastener. In an exemplary aspect, the first and second bar attachment mechanisms 212a, 212b may be inserted into the hooks 214, such that the first and second bar attachment mechanisms 212a, 212b may be flexibly attached to the hooks 214.

The first and second bar attachment mechanisms 212a, 212b may be similar to/same as each other, and may be, for example, eye bolts, D-rings, carabiners, snap hooks, and/or the like. In the exemplary and preferred aspect depicted in FIGS. 2 and 3, the first and second bar attachment mechanisms 212a, 212b are carabiners.

The first vest attachment mechanism 208a may be configured to be removably attached with the first bar attachment mechanism 212a and the second vest attachment mechanism 208b may be configured to be removably attached with the second bar attachment mechanism 212b to enable removable attachment between the vest 110 and the rigid elongated member 112. Specifically, the pet owner may engage or attach the first vest attachment mechanism 208a with the first bar attachment mechanism 212a and the second vest attachment mechanism 208b with the second bar attachment mechanism 212b to arrange the apparatus 108 in an assembled mode, as shown in FIG. 2. As described above in conjunction with FIG. 1, the rigid elongated member longitudinal axis “L1” (shown in FIG. 1) may be perpendicular to the pet longitudinal axis “L2” or the pet length when the apparatus 108 may be arranged in the assembled mode (and the pet 102 may be wearing the apparatus 108). Stated another way, the rigid elongated member longitudinal axis “L1” may be perpendicular to the pet longitudinal axis “L2” or the pet length when the first vest attachment mechanism 208a may be attached with the first bar attachment mechanism 212a and the second vest attachment mechanism 208b may be attached with the second bar attachment mechanism 212b (and the pet 102 may be wearing the apparatus 108).

In a similar manner, the pet owner may disengage or detach the first vest attachment mechanism 208a from the first bar attachment mechanism 212a and the second vest attachment mechanism 208b from the second bar attachment mechanism 212b to disassemble the apparatus 108, as shown in FIG. 3. Specifically, the pet owner may disengage the carabiners (i.e., the first and second bar attachment mechanisms 212a, 212b) from the D-rings (i.e., the first and second vest attachment mechanisms 208a, 208b) to conveniently disassemble the apparatus 108, as shown in FIG. 3.

In an exemplary aspect, the pet owner may make the pet 102 wear the vest 110 (or adhere the vest 110 to the pet body) and arrange the apparatus 108 in the assembled mode when the pet 102 may be located alone in the garden 104 and the pet owner may desire to prevent the pet 102 from escaping through the fences 106. Further, in an exemplary aspect, the pet owner may disassemble the apparatus 108 when the pet 102 may be located indoors or when the pet owner may be present along with the pet 102. In this case, responsive to disassembling the apparatus 108 or removing the rigid elongated member 112 from the vest 110 (and the vest 110 being still adhered to the pet body), the pet owner may connect/attach a pet leash to the first and second vest attachment mechanisms 208a, 208b (i.e., the D-rings) and conveniently move the pet 102. In this manner, the vest 110 may be used by the pet owner even after the rigid elongated member 112 may be removed from the vest 110.

FIG. 4 depicts an example rigid elongated member 400 (that may be part of the apparatus 108) in accordance with the present disclosure. The rigid elongated member 400 may be similar to the rigid elongated member 112; however, the rigid elongated member 400 may include one or more additional features as compared to the rigid elongated member 112 described above.

In some aspects, the rigid elongated member 400 may include a telescoping mechanism 402 disposed on a bar proximal portion 404a, a bar distal portion 404b or a bar middle portion 404c. In the exemplary aspect depicted in FIG. 4, the telescoping mechanism 402 is shown to be disposed on the bar distal portion 404b. The telescoping mechanism 402 may enable the pet owner to adjust a rigid elongated member length. For example, the pet owner may decrease the rigid elongated member length via the telescoping mechanism 402 when the gaps between adjacent fences may be smaller or the pet owner may desire to carry the rigid elongated member 400 (e.g., in a bag) when the apparatus 108 may be in a disassembled state. Similarly, the pet owner may increase the rigid elongated member length via the telescoping mechanism 402 when the gaps between adjacent fences may be larger, to prevent the pet 102 from escaping through the fences 106.

In some aspects, when the telescoping mechanism 402 may be disposed on the bar distal portion 404b (as shown in FIG. 4), the pet owner may slide the bar distal portion 404b away from the bar middle portion 404c to increase the rigid elongated member length, and may slide the bar distal portion 404b towards the bar middle portion 404c to decrease the rigid elongated member length. The rigid elongated member 400 may further include a locking mechanism or a lock (not shown) that may enable the pet owner to lock or fix the rigid elongated member length when the pet owner may have slid the bar distal portion 404b to a desired position/length. Examples of the lock include, but are not limited to, a twist-turn lock, a press-and-push lock, a ball-and-detent lock, or any other locking mechanism that enables two parts to lock in a defined position.

In additional or alternative aspects, the rigid elongated member 400 may have a hollow interior portion that may be used to store one or more artifacts, e.g., pet litter/poop bags, pet snacks, an electronic pet locating device, and/or other small objects. In this case, the rigid elongated member 400 may include an opening 406 disposed at a rigid elongated member proximal end or a rigid elongated member distal end, which may be accessed by the pet owner via a removable cap 408. The removable cap 408 may be made of same material as the rigid elongated member 400, and may be configured to be disposed at or removably attached to the rigid elongated member proximal end or the rigid elongated member distal end. In the exemplary aspect depicted in FIG. 4, the removable cap 408 is configured to be removably attached to the rigid elongated member proximal end.

During operation, the pet owner may remove the removable cap 408 from the rigid elongated member proximal end to access the hollow interior portion of the rigid elongated member 400 via the opening 406, and place one or more artifacts described above in the hollow interior portion. Stated another way, the hollow interior portion may be configured to receive the artifacts from the pet owner via the opening 406/rigid elongated member proximal end (or the rigid elongated member distal end when the removable cap 408 may be placed at the distal end). Responsive to placing the artifacts in the hollow interior portion, the pet owner may re-attach the removable cap 408 to the rigid elongated member proximal end, thereby enabling safe storage of the artifacts. A person ordinarily skilled in the art may appreciate that when the artifact is an electronic pet locating device, the apparatus 108 may provide additional level of security to the pet 102, as the pet owner may be able to track pet's location when the pet 102 wears the apparatus 108.

In some aspects, the removable cap 408 may be any cap including, but not limited to, a screw cap, a hinged cap, and/or the like. Remaining components/details of the rigid elongated member 400 are same as the components/details of the rigid elongated member 112, and hence are not described again here for the sake of simplicity and conciseness.

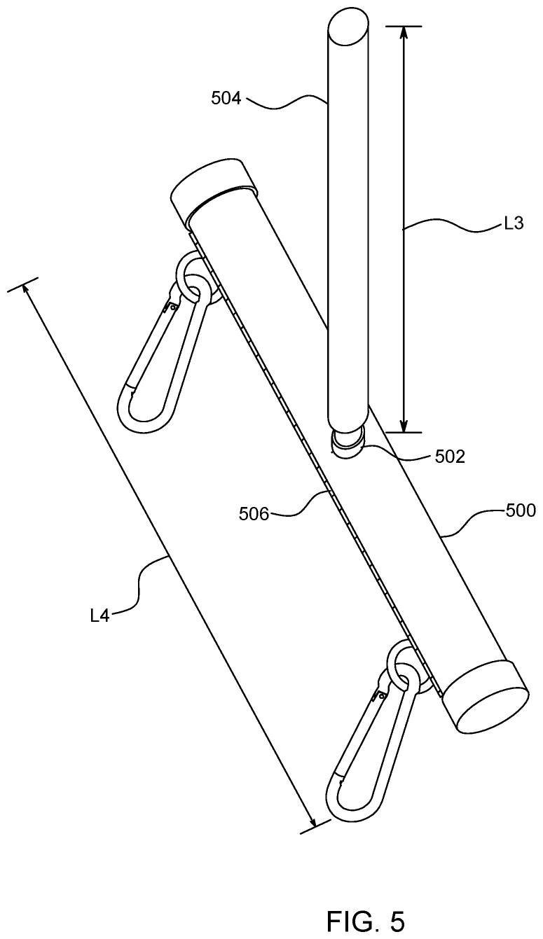

FIG. 5 depicts an example rigid elongated member 500 (that may be part of the apparatus 108) in accordance with the present disclosure. The rigid elongated member 500 may be similar to the rigid elongated members 112, 400 described above; however, the rigid elongated member 500 may include one or more additional components/features as compared to the rigid elongated members 112, 400.

The rigid elongated member 500 may include a bar connector 502 that may be disposed anywhere along the rigid elongated member length. In the exemplary aspect depicted in FIG. 5, the bar connector 502 may be disposed at a rigid elongated member center portion and may be, for example, a T-connector, a slot connector, and/or the like. The bar connector 502 may be configured to removably attach with a connecting bar 504 (that may be part of the apparatus 108). The connecting bar 504 may be a rigid elongated member similar to the rigid elongated members 112, 400, 500, and may be made of similar material and/or have similar dimensions.

In some aspects, when the connecting bar 504 attaches to the bar connector 502, a longitudinal axis “L3” of the connecting bar 504 may be perpendicular to a longitudinal axis “L4” of the rigid elongated member 500, as shown in FIG. 5. In such an arrangement, the connecting bar 504 prevents the pet 102 from escaping through the bottom portion of the fences 106 when the pet 102 may be wearing the apparatus 108 including the connecting bar 504 attached to the bar connector 502. Stated another way, the connecting bar 504 prevents pet escape from under the fences 106 when the pet 102 wears the apparatus 108 including the connecting bar 504 attached to the bar connector 502 in the arrangement depicted in FIG. 5.

In further aspects, the rigid elongated member 500 may include a cushion strip 506 that may be attached to the rigid elongated member body and disposed along an entire length or a portion of the length of the rigid elongated member 500, as shown in FIG. 5. The cushion strip 506 may be made of thick fabric or rubber, and may be disposed on that portion of the rigid elongated member 500 that may touch the vest 110 and/or the pet skin. The cushion strip 506 may provide comfort to the pet 102 when the pet 102 may be wearing the apparatus 108.

Although the description above describes aspects where the telescoping mechanism 402 and the removable cap 408 are part of the rigid elongated member 400, and the bar connector 502 and the cushion strip 506 are part of the rigid elongated member 500, in some aspects, the telescoping mechanism 402, the removable cap 408, the bar connector 502 and/or the cushion strip 506 may be part of the rigid elongated member 112.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. An apparatus comprising:
a vest configured to be removably adhered to a pet body, wherein the vest comprises a vest interior surface and a vest exterior surface;
a rigid elongated member comprising a proximal portion and a distal portion, wherein the rigid elongated member further comprises a bar connector disposed at a rigid elongated member middle portion;
a first attachment mechanism disposed on the vest exterior surface;
a second attachment mechanism disposed on the rigid elongated member, wherein:
the first attachment mechanism is configured to be removably attached to the second attachment mechanism to enable removable attachment between the vest and the rigid elongated member, and
a rigid elongated member longitudinal axis is perpendicular to a pet body length when the first attachment mechanism is attached to the second attachment mechanism; and
a connecting bar, wherein the bar connector is configured to removably attach to the connecting bar such that a connecting bar longitudinal axis is perpendicular to the rigid elongated member longitudinal axis and the pet body length when the first attachment mechanism is attached to the second attachment mechanism.

2. The apparatus of claim 1, wherein the second attachment mechanism is disposed on at least one of the proximal portion, the distal portion or a rigid elongated member middle portion.

3. The apparatus of claim 1, wherein the first attachment mechanism is at least one of an eye bolt, a D-ring and a carabiner.

4. The apparatus of claim 1, wherein the second attachment mechanism is at least one of an eye bolt, a D-ring and a carabiner.

5. The apparatus of claim 1, wherein the vest interior surface is configured to touch the pet body when the vest is adhered to the pet body.

6. The apparatus of claim 1, wherein the vest further comprises a front portion and a back portion, and wherein the first attachment mechanism is disposed on a middle part of the back portion.

7. The apparatus of claim 1, further comprising a third attachment mechanism disposed on the vest exterior surface and a fourth attachment mechanism disposed on the proximal portion, wherein the second attachment mechanism is disposed on the distal portion.

8. The apparatus of claim 7, wherein the third attachment mechanism is similar to the first attachment mechanism and the fourth attachment mechanism is similar to the second attachment mechanism.

9. The apparatus of claim 7, wherein the third attachment mechanism is configured to be removably attached to the fourth attachment mechanism.

10. The apparatus of claim 1, wherein the rigid elongated member is shaped as a cylindrical or a cuboidal bar.

11. The apparatus of claim 1, wherein the rigid elongated member further comprises a telescoping mechanism disposed on at least one of a rigid elongated member middle portion, the proximal portion and the distal portion, and wherein the telescoping mechanism is configured to adjust a rigid elongated member length.

12. The apparatus of claim 1, wherein the rigid elongated member further comprises a hollow interior portion and a removable cap disposed on at least one of a rigid elongated member proximal end and a rigid elongated member distal end.

13. The apparatus of claim 12, wherein the hollow interior portion is configured to receive one or more artifacts via the at least one of the rigid elongated member proximal end and the rigid elongated member distal end when the removable cap is removed.

14. (canceled)

15. (canceled)

16. The apparatus of claim 1, wherein the rigid elongated member further comprises a cushion strip disposed along a portion of a rigid elongated member length, wherein the cushion strip is a part of the rigid elongated member.

17. An apparatus comprising:
a vest configured to be removably adhered to a pet body, wherein the vest comprises a vest interior surface and a vest exterior surface;
a rigid elongated member comprising a proximal portion and a distal portion, wherein the rigid elongated member further comprises a bar connector disposed at a rigid elongated member middle portion;
a first attachment mechanism and a second attachment mechanism disposed on the vest exterior surface;
a third attachment mechanism and a fourth attachment mechanism disposed on the rigid elongated member, wherein:
the first attachment mechanism and the second attachment mechanism are configured to be removably attached to the third attachment mechanism and the fourth attachment mechanism respectively to enable removable attachment between the vest and the rigid elongated member, and
a rigid elongated member longitudinal axis is perpendicular to a pet body length when the first attachment mechanism and the second attachment mechanism are attached to the third attachment mechanism and the fourth attachment mechanism; and
a connecting bar, wherein the bar connector is configured to removably attach to the connecting bar such that a connecting bar longitudinal axis is perpendicular to the rigid elongated member longitudinal axis and the pet body length when the first attachment mechanism is attached to the second attachment mechanism.

18. The apparatus of claim 17, wherein the first attachment mechanism, the second attachment mechanism, the third attachment mechanism and the fourth attachment mechanism are at least one of an eye bolt, a D-ring and a carabiner.

19. The apparatus of claim 17, wherein the rigid elongated member is shaped as a cylindrical or a cuboidal bar.

20. An apparatus comprising:
a vest configured to be removably adhered to a pet body, wherein the vest comprises a vest interior surface and a vest exterior surface;
a rigid elongated member comprising a proximal portion and a distal portion, wherein the rigid elongated member further comprises a bar connector disposed at a rigid elongated member middle portion;
a first attachment mechanism disposed on the vest exterior surface, wherein the first attachment mechanism is at least one of an eye bolt, a D-ring and a carabiner;
a second attachment mechanism disposed on the rigid elongated member, wherein the second attachment mechanism is at least one of an eye bolt, a D-ring and a carabiner, wherein:
the first attachment mechanism is configured to be removably attached to the second attachment mechanism to enable removable attachment between the vest and the rigid elongated member, and
a rigid elongated member longitudinal axis is perpendicular to a pet body length when the first attachment mechanism is attached to the second attachment mechanism; and
a connecting bar, wherein the bar connector is configured to removably attach to the connecting bar such that a connecting bar longitudinal axis is perpendicular to the rigid elongated member longitudinal axis and the pet body length when the first attachment mechanism is attached to the second attachment mechanism.

21. The apparatus of claim 1, wherein the connecting bar longitudinal axis is perpendicular to the ground when the first attachment mechanism is attached to the second attachment mechanism.
